(19) United States
(12) Patent Application Publication
(10) Pub. No.: US 2018/0192798 A1
(43) Pub. Date: Jul. 12, 2018

(54) INFLATABLE U-SHAPED PILLOW

(71) Applicant: SHENZHEN COLORFUL FASHION HANDBAGS CO., LTD, Shenzhen (CN)

(72) Inventor: ShengPing Song, Shenzhen (CN)

(21) Appl. No.: 15/446,031

(22) Filed: Mar. 1, 2017

(30) Foreign Application Priority Data
Jan. 6, 2017 (CN) 201720014540.4

(51) Int. Cl. A47G 9/10; A47C 7/38; F04D 17/10; H04M 1/21

(52) U.S. Cl. CPC A47G 9/1027; A47C 7/383; A47G 2009/003; H04M 1/21; F04D 17/10

(57) ABSTRACT

An inflatable U-shaped pillow includes a body and an inflatable device arranged on the body, where the inflatable device includes a draught fan, a connector electrically connected to the draught fan via signal line, and the connector is connected to an external power supply device to drive the draught fan. The inflatable device is configured to a storage chamber; the signal line is placed in the storage chamber, and the signal line is pulled out from the storage chamber; an air outlet of the draught fan is matched with the inflatable hole; the draught fan generates gas, and the gas is transmitted in the inflatable hole from the air outlet of the draught fan.

### BACKGROUND

### 1. Field of the Disclosure

The present disclosure relates to the field of U-shaped pillows, and more particularly to an inflatable U-shaped pillow.

### 2. Description

With the development of society, life stress and work pressure is increasing. Most people often sit in the face of a computer and keep sitting posture for some hours, or even longer, all kinds of cervical spondylosis, scapulohumeral periarthritis afflicts most people. Conventional pillow cannot fit all people cervical spine, which is not comfortable enough, affects rest and sleep quality, and increases pressure of the cervical spine and shoulder burden, even further causing stiff neck. The conventional pillow having a pillow inner after a long time to use easily deforms and collapses, further reducing use comfort.

Therefore, U-shaped pillows are widely used because the U-shaped pillows are suitable for cervical spine. The U-shaped pillows only need to be clamped on the people neck and attached above the shoulder when the users use the U-shaped pillow. Then, when people back is against a seat, the U-shaped pillows have a powerful support for people head. When people are sleeping, the people head will not swing, which protects the people neck. The U-shaped pillows are widely used as household, staff in the lunch break, business and long distance travel because the U-shaped pillows are convenient to use.

Conventional U-shaped pillows have silk-floss-type filler U-shaped pillows and inflatable U-shaped pillows. An inflatable hole are arranged on a body of the inflatable U-shaped pillows, Users use mouth to inflate at a position of the inflatable hole, and the body of the inflatable U-shaped pillows is filled with gas. However, the above inflatable way is unsanitary and inconvenient, and makes the users security risk.

### SUMMARY

The aim of the present disclosure is to provide an inflatable U-shaped pillow capable of easily and sanitarily inflating.

Other objects, advantages and novel features of the present disclosure will become more apparent from the following detailed description when taken in conjunction with the accompanying drawings.

### BRIEF DESCRIPTION OF THE DRAWINGS

The including drawings is used to provide a further understanding of the embodiment of the present disclosure, which forms a part of the specification, uses to exemplify the embodiment of the present disclosure, and combines with text description to interpret theory of the present disclosure. Obviously the following description is only a few embodiments, for the common technical personnel in the field it is easy to acquire some other drawings without creative work. In the drawing:

FIG. 1 is a structural diagram of an inflatable U-shaped pillow of one embodiment of the present disclosure.

FIG. 2 is a structural diagram of an inflatable U-shaped pillow of one embodiment of the present disclosure.

FIG. 3 is a structural diagram of an inflatable U-shaped pillow of one embodiment of the present disclosure.

FIG. 4 is a structural diagram of a body of one embodiment of the present disclosure.

FIG. 5 is a structural diagram of an inflatable device of one embodiment of the present disclosure.

FIG. 6 is a structural diagram of an inflatable device of one embodiment of the present disclosure.

FIG. 7 is a structural diagram of an inflatable device of one embodiment of the present disclosure.

FIG. 8 is a structural diagram of an inflatable device of one embodiment of the present disclosure.

FIG. 9 is a structural diagram of a draught fan of one embodiment of the present disclosure.

FIG. 10 is a schematic diagram of an inflatable U-shaped pillow connected to cell phones of one embodiment of the present disclosure.

FIG. 11 is a schematic diagram of an inflatable U-shaped pillow connected to cell phones of one embodiment of the present disclosure.

FIG. 12 is a schematic diagram of an inflatable U-shaped pillow connected to cell phones of one embodiment of the present disclosure.

FIG. 13 is a schematic diagram of an inflatable U-shaped pillow connected to mobile chargers of one embodiment of the present disclosure.

FIG. 14 is a schematic diagram of a draught fan matching with air compressor of one embodiment of the present disclosure.

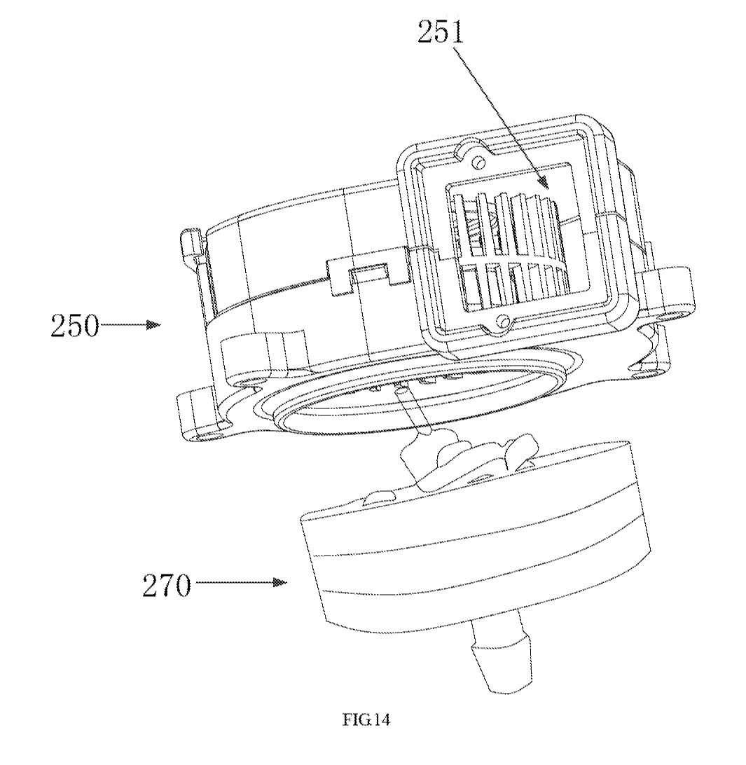

### DETAILED DESCRIPTION

The present disclosure will further be described in detail in accordance with the figures and the exemplary examples.

The following description of every embodiment with reference to the accompanying drawings is used to exemplify a specific embodiment, which may be carried out in the present invention. Directional terms mentioned in the present invention, such as “top”, “bottom”, “front”, “back”, “left”, “right”, “inside”, “outside”, “side” etc., are only used with reference to the orientation of the accompanying drawings. Therefore, the used directional terms are intended to illustrate, but is not to limit, the present invention.

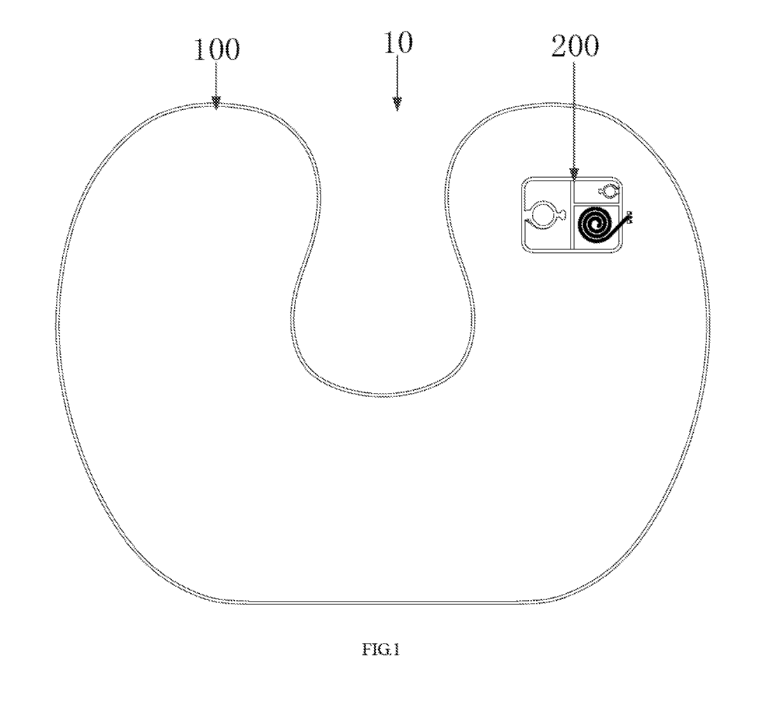

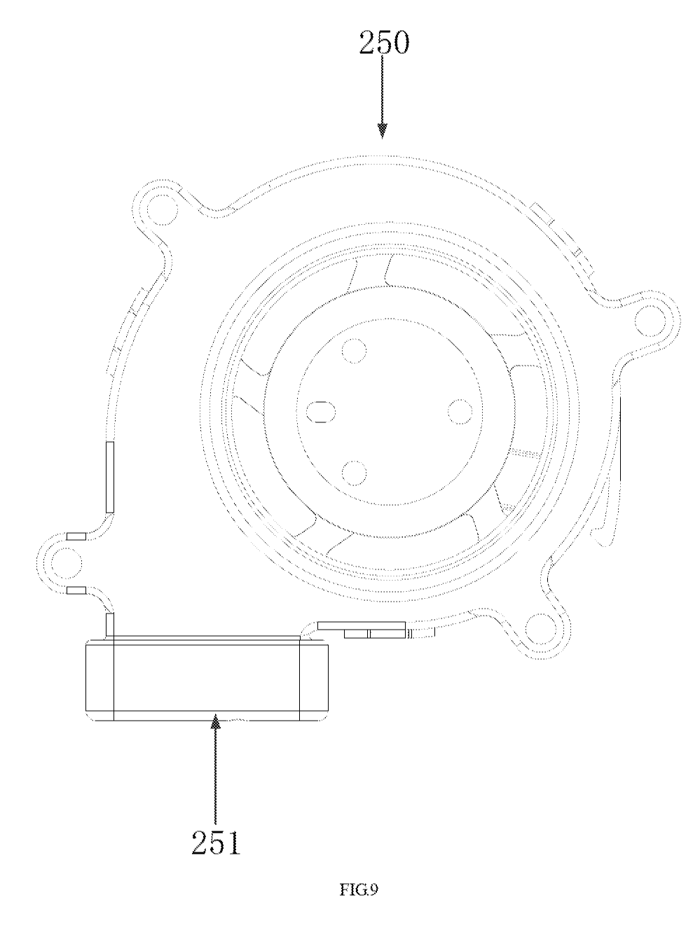

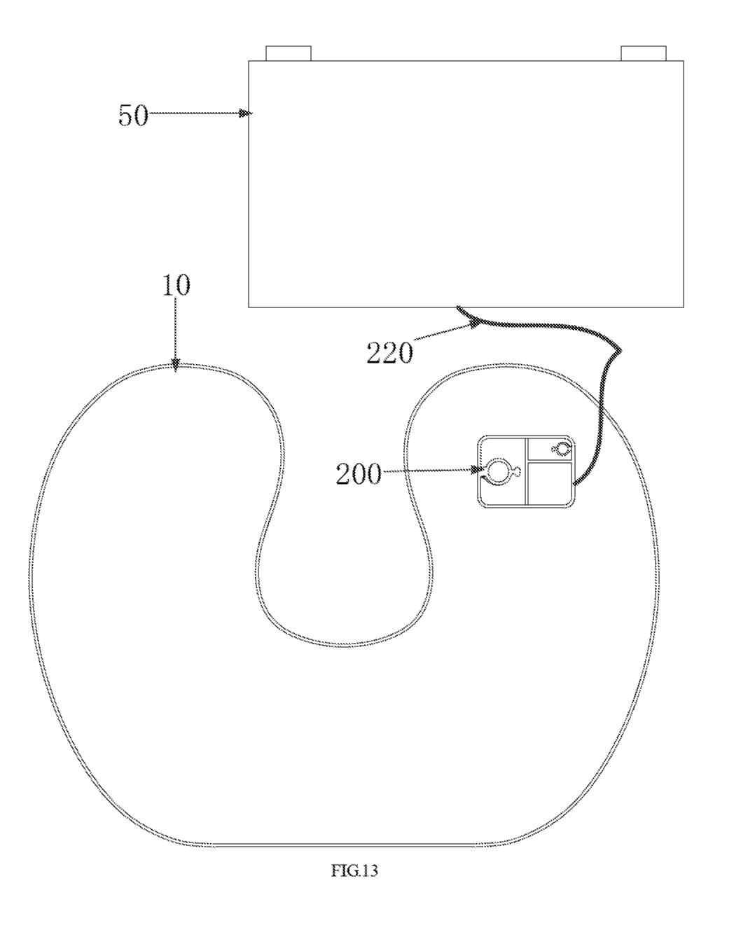

FIG. 1 to FIG. 13 describes an inflatable U-shaped pillow of the embodiment of the present disclosure.

As shown in FIG. 1 to FIG. 13, the inflatable U-shaped pillow 10 of the embodiment of the present disclosure comprises a body 100 and a inflatable device 200 arranged on the body 100, where the inflatable device is used to inflate for the body 100.

In the embodiment, the body 100 is configured to an inflatable hole 140, and the inflatable hole 140 matches with the inflatable device 200. The inflatable device 200 inflates for the body 100 via the inflatable hole 140, which is convenient for the user. When the user does not use the inflatable U-shaped pillow 10 of the present disclosure, the user can vent gas via the inflatable hole 140 to be convenient to carry the inflatable U-shaped pillow that the body of the inflatable U-shaped pillow does not have gas.

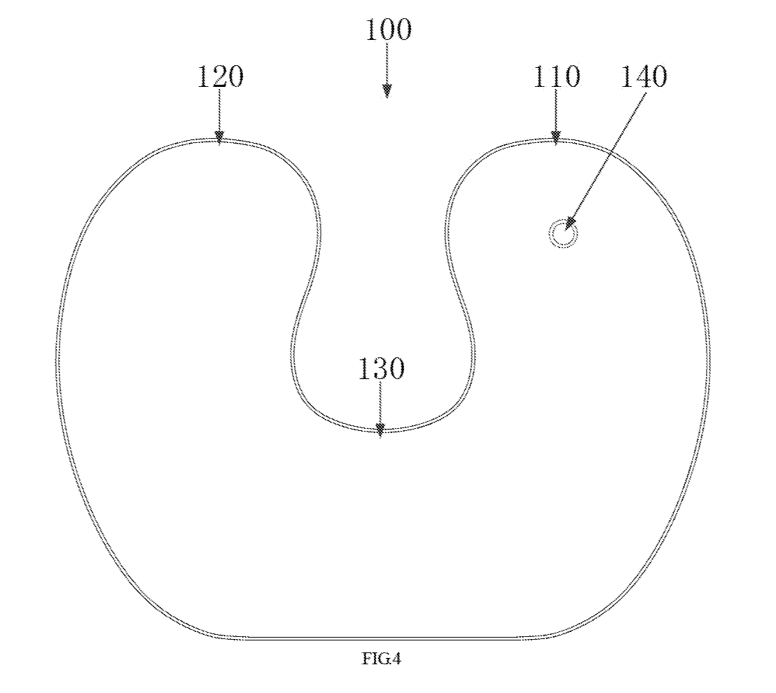

In the embodiment, the body is a U-shaped structure, where the body comprises a first end 110, a second end 120 and a third end 130 between the first end 110 and the second end 120 as shown in FIG. 4. The number of the inflatable hole 140 is one, one inflatable hole 140 is arranged on the first end 110 of the body, correspondingly, the number of the inflatable device 200 is one, one inflatable device 200 also is arrange on the first end 110 of the body 100 as shown in FIG. 1. The above description is a particular way of the inflatable hole and the inflatable device of the present disclosure, it should be understood that the embodiment is limited in the above description.

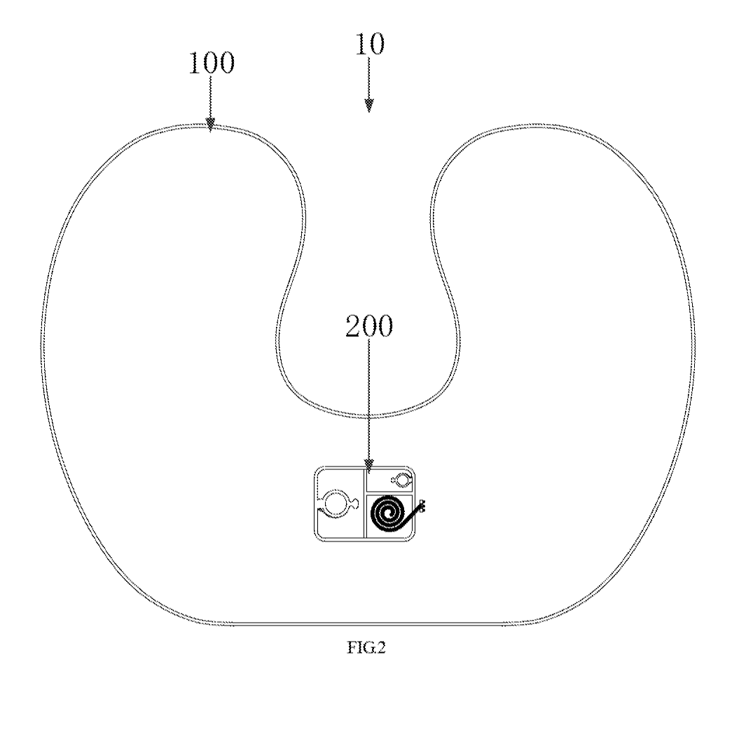

For example one: as shown in FIG. 2, the inflatable hole is arranged on the third end of the body 100, and the inflatable device 200 is arranged on the third end of the body 100.

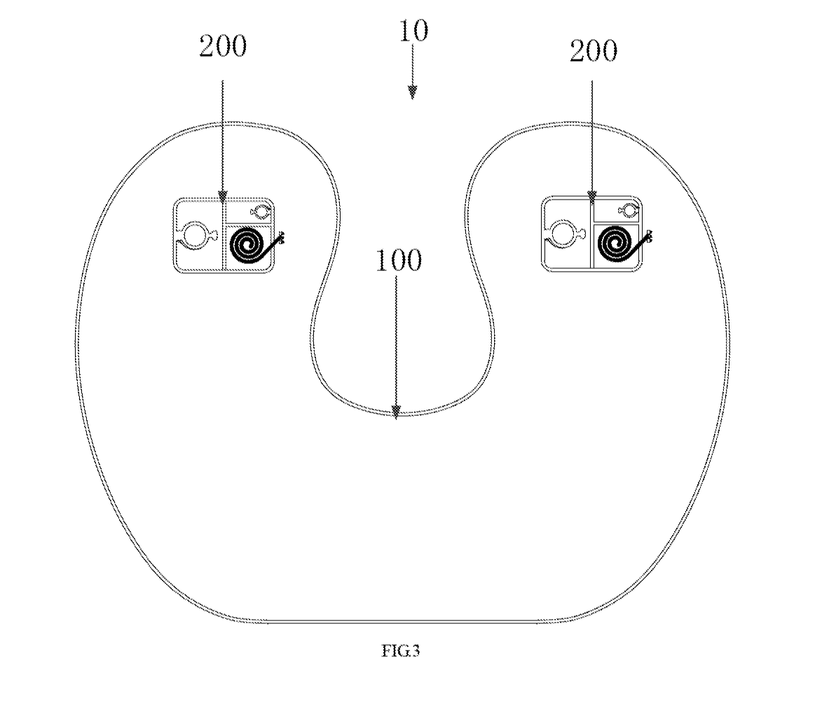

For example two: as shown in FIG. 3, the number of the inflatable hole is two, a first inflatable hole is arranged on the first end of the body 100, and a second inflatable hole is arranged on the second end of the body 100. Correspondingly, the number of the inflatable device is two, a first inflatable device is arranged on the first end of the body 100, and a second inflatable device is arranged on the second end of the body 100. Thus, two inflatable devices control the two inflatable holes, respectively, which improve air inflation and air bleeding, and is convenient for the user.

For example three: the inflatable hole is arranged on the second end of the body 100, and the inflatable device 200 is arranged on the second end of the body 100

It should be explained, the above embodiments are only some kind of particular ways of the inflatable hole and the inflatable device of the present disclosure. The present disclosure also can have other structure and way. Therein, the number of the inflatable hole of the present disclosure can be more.

In the embodiment, the inflatable device 200 is arranged on the body 100, where the inflatable device 200 comprises a draught fan 250 and a connector 210 electrically connected to the draught fan 250 by signal line 220. The connector 210 is used to connect to external power supply device to drive the draught fan 250. The connector 210 of the inflatable U-shaped pillow 10 of the embodiment of the present disclosure is electrically connected to the external power supply device, such as the connector 210 is connected to cell phones or mobile chargers, and the cell phones or the mobile chargers can provide the power for the inflatable device to drive the draught fan of the inflatable device. The draught fan operates and generates gas, and the gas is transmitted in the body via air outlet of draught fan matching with the inflatable hole, furthermore, the body is filled with the gas to use for the user. Thus, compared with a U-shaped pillow using mouth to inflate gas, the present disclosure only uses the cell phones or the mobile chargers to inflate the gas without the mouth, which is convenient to inflate gas for the user, is sanitary and avoids security risk during inflating the gas by the users. At the same time, there is no need to arrange power device in the body, and the entire structure of the inflatable device is easy, the users only uses the cell phone to connect to the inflatable device of the present disclosure to provide the power for the inflatable device because the user uses the cell phones anywhere and anytime. Furthermore, the draught fan operates and the body is inflated by gas. In addition, the gas of the body can be vented when the user does not use, which is convenient to carry.

It should be understood that the external power device of the embodiment of the present disclosure comprises but not limited to the cell phones, the mobile chargers, and tablet personal computers.

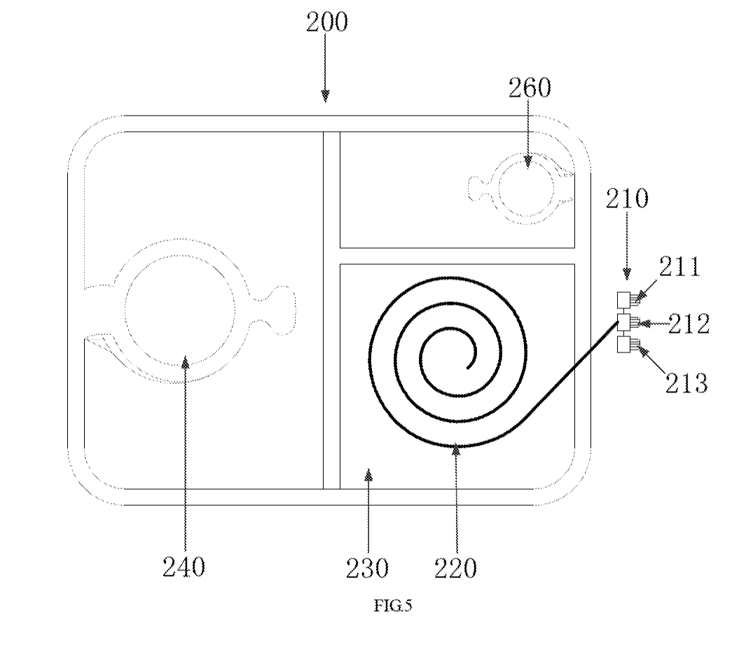

It should be understood that the number of the connector 210 of the present disclosure is at least one, to be specific, as shown in FIG. 5, the number of the connector 210 of the present disclosure is three: a first connector 211, a second connector 212, and a third connector 213.

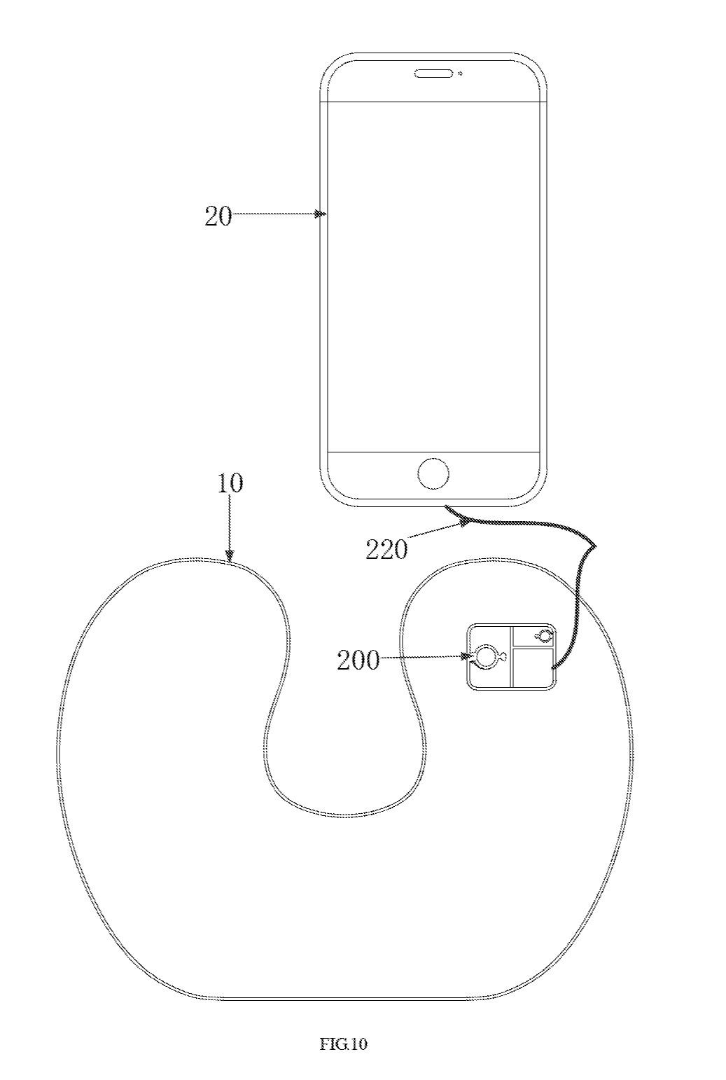

Combined with FIG. 10, the first connector 211 is connected to a first cell phone 20, and the inflatable device is provided for the power via the first cell phone 20. To be specific, the first cell phone 20 (such as IPHONE) comprises a first interface (or IPHONE interface), where the first interface is electrically connected to the first connector to provide the power for the inflatable device.

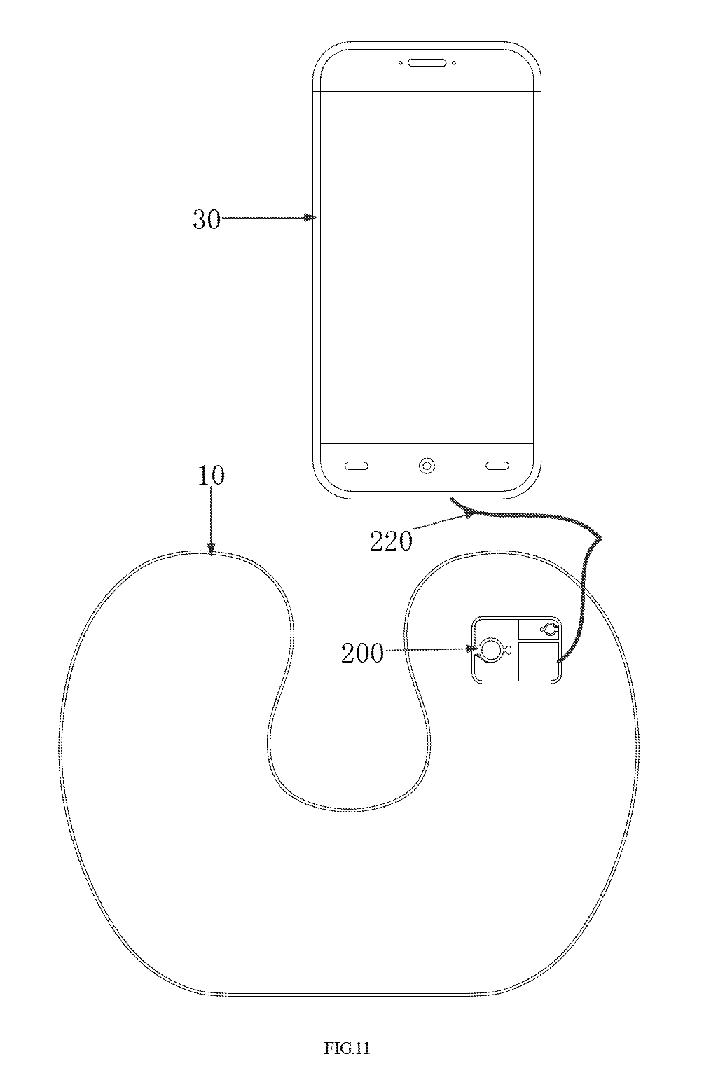

Combined with FIG. 11, the second connector 212 is connected to a second cell phone 30, and the inflatable device is provided for the power via the second cell phone 30. To be specific, the second cell phone 30 (such as HUAWEI PHONE) comprises a second interface (ANDROID interface), where the second interface is electrically connected to the second connector to provide the power for the inflatable device.

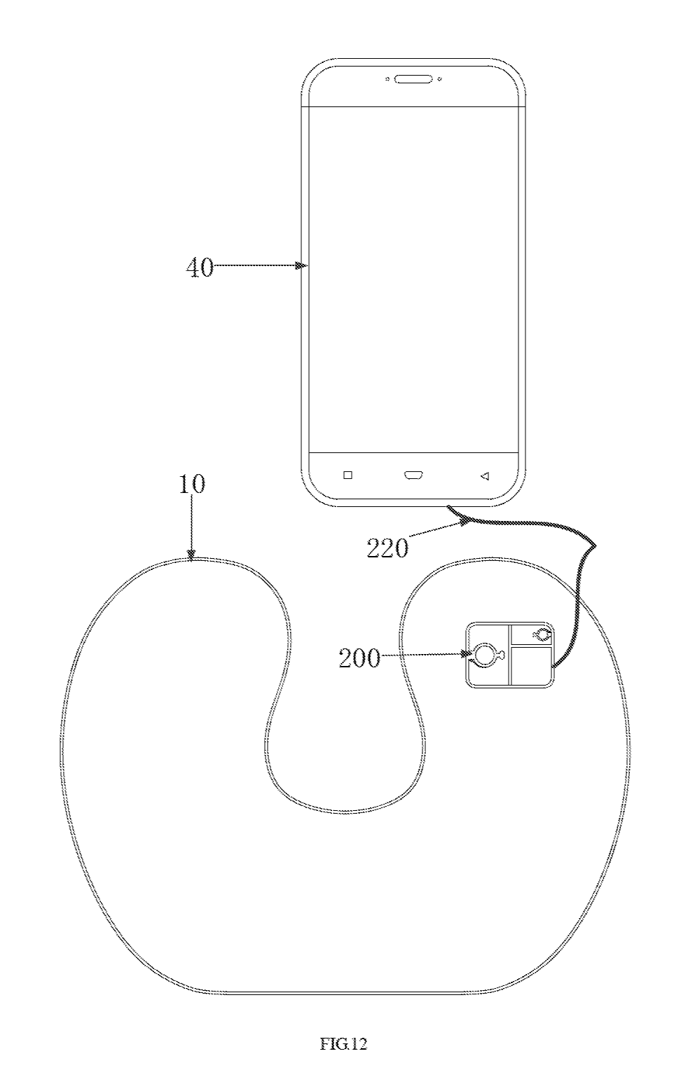

Combined with FIG. 12, the third connector 213 is connected to a third cell phone 40, and the inflatable device is provided for the power via the third cell phone 40. To be specific, the third cell phone 40 comprises a third interface (Type-C interface), where the third interface is electrically connected to the third connector to provide the power for the inflatable device.

It should be understood that the connector of the embodiment of the present disclosure is not limed in the above embodiment.

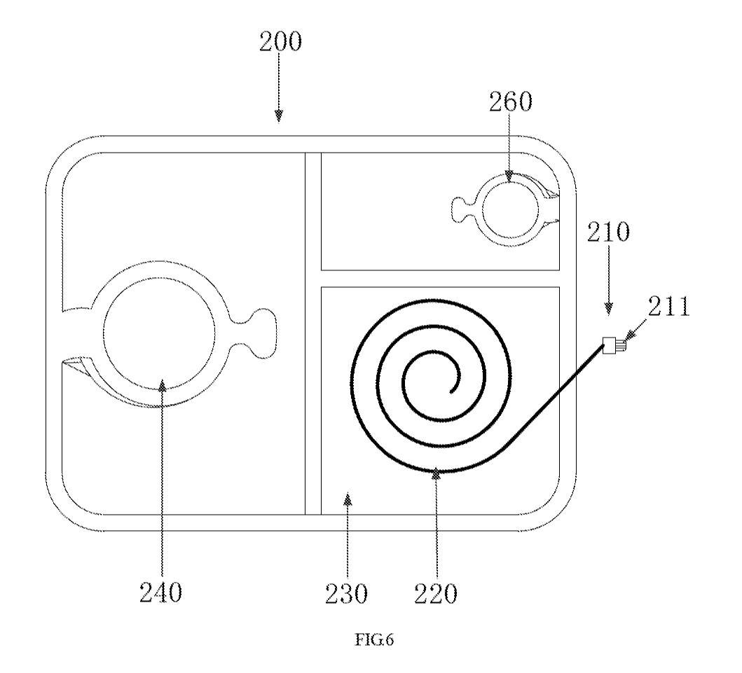

For example one: as shown in FIG. 6, the number of the connector 210 only is one, which is regarded as the first connector 211. The first connector 211 only can be connected to one interface. Therein, the first connector refers to the above description, there will be not described.

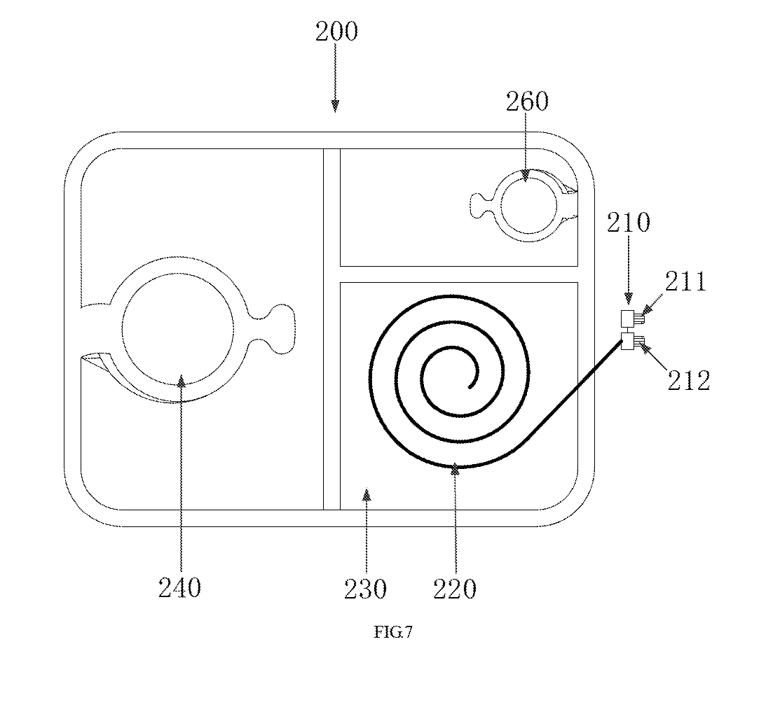

For example two: as shown in FIG. 7, the number of the connector 210 is two, which are regarded as the first connector 211 and the second connector 212. Therein, the first connector 211 and the second connector 212 refer to the above description, there will be not described.

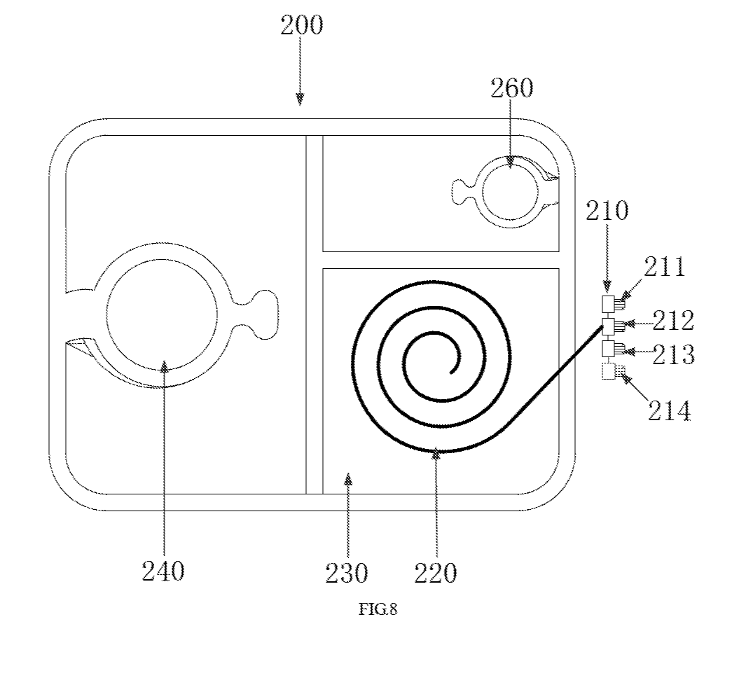

For example three: as shown in FIG. 8, the number of the connector 210 is four, which are regarded as the first connector 211, the second connector 212, the third connector 213, and a fourth connector 214. Therein, the first connector 211, the second connector 212 and the third connector 213 refer to the above description, there will be not described. Combined with 13, the fourth connector 214 is connected to the charger 60 to provide the power for the inflatable device. To be specific, the charger is 5 voltage charger.

It should be understood that the embodiment of the present disclosure can use the mobile charger to provide the power for the inflatable device.

In the embodiment of the present disclosure, furthermore, the inflatable device 200 is configured to a storage chamber 230 placing signal line 220. The signal line 220 is placed in the storage chamber 230, and the signal line 220 can be pulled out from the storage chamber 230. The air outlet 251 of the draught fan 250 is matched with the inflatable hole 140. The draught fan operates and generates gas, and the gas is transmitted to the inflatable hole and enters into the body via air outlet of the draught fan. The connector of the embodiment of the present disclosure is electrically connected to the draught fan by the signal line, and the signal line 220 is placed in the storage chamber 230. When the connector is no need to be connected, the signal line 220 can be placed in the storage chamber 230, which avoids the signal line exposing outside and causing being carried and placed for the user. When the connector is need to be connected, the signal line 220 can be pulled out from the storage chamber 230 to be connected to the external power device, which is convenient for the user to use.

Furthermore, a storage groove is arranged on an edge of the storage chamber, where the storage groove is used to place the connector 210. Namely, the connector 210 is placed in the storage groove to avoid exposure outside. To be specific, a notch of the storage groove gradually becomes smaller from an opening of the storage groove to a bottom of the storage groove, and a middle portion of the storage groove is adapted to a size of the connector, which is convenient that the connector is inserted into the storage groove and the deeper that the connector is inserted into the storage groove, the closer that the connector is matched with the storage groove.

In the present disclosure, the draught fan of the present disclosure can be different types to meet requirement of the different wind pressure. A size of the draught fan of the embodiment of the present disclosure is small, and power supply time is 10 to 30 seconds during the cell phone provides the power for the inflatable device. The draught fan is driven in 10 to 30 seconds to inflate the body. It should be understood that different draught fan and different cell phone need different power supply time.

In order to further increase the wind pressure of the draught fan, the inflatable device of the embodiment of the present disclosure further comprises air compressor, where the air compressor is connected to the draught fan to increase the wind pressure of the draught fan, which ensures that the draught fan outputs enough wind pressure. To be specific, in the embodiment of the present disclosure, one draught fan is connected to one air compressor. It should be understood that the draught fan connected to the air compressor is not limited in the above description. For example: it should can understood that two air compressors are connected to one draught fan to increase the wind pressure of the draught fan, or two draught fans are connected to one air compressor.

In the embodiment of the present disclosure, when the user does not use the inflatable U-shaped pillow, the gas of the body can be vented. In order to be convenient to vent the gas, the air outlet 260 is arranged on the inflatable device 200 of the present disclosure, the user can open the air outlet 260 to vent the gas from the body. To be specific, a leakproof cover covers in the air outlet, when the user does not use the inflatable U-shaped pillow, the leakproof cover is opened and the gas of the body can quickly be vented. When the body is inflated by the gas, the leakproof cover is closed, a leakproof cover of the air inlet 240 is opened to inflate, when the body is filled with the gas, the leakproof cover of the air inlet 240 is closed. At this time, the air inlet and air outlet are closed by the leakproof cover of the air inlet and leakproof cover of the air outlet, respectively, to avoid gas leakage.

In the embodiment of the present disclosure, the body is made of thermoplastic polyurethanes elastomer (TPU), which has some advantages, such as comfortable hand feel, thin and soft, easy to place.

As the above, it should be understood that the present disclosure has been described with reference to certain preferred and alternative embodiments which are intended to be exemplary only and do not limit the full scope of the present disclosure as set fourth in the appended claims.

What is claimed is:

1. An inflatable U-shaped pillow, comprising:
a body configured to an inflatable hole; wherein the body comprises a first end, a second end and a third end between the first end and the second end, and the inflatable hole is arranged on the first end of the body, and
an inflatable device arranged on the body; wherein the inflatable device is arrange on the first end of the body; the inflatable device comprises a draught fan, a connector electrically connected to the draught fan via signal line, and an air compressor connected to the draught fan; the connector is connected to an external power supply device to drive the draught fan; the connector comprises a first connector, a second connector and a third connector; an air outlet is arranged on the inflatable device to vent gas;
wherein the inflatable device is configured to a storage chamber; the signal line is placed in the storage chamber, and the signal line is pulled out from the storage chamber; an air outlet of the draught fan is matched with the inflatable hole; the draught fan generates gas, and the gas is transmitted in the inflatable hole from the air outlet of the draught fan;
wherein a notch of the storage groove gradually becomes smaller from an opening of the storage groove to a bottom of the storage groove, and a middle portion of the storage groove is adapted to a size of the connector.

2. An inflatable U-shaped pillow, comprising:
a body configured to an inflatable hole; and
an inflatable device arranged on the body; wherein the inflatable device comprises a draught fan, a connector electrically connected to the draught fan via signal line; the connector is connected to an external power supply device to drive the draught fan;
wherein the inflatable device is configured to a storage chamber, the signal line is placed in the storage chamber, and the signal line is pulled out from the storage chamber; an air outlet of the draught fan is matched with the inflatable hole; the draught fan generates gas, and the gas is transmitted in the inflatable hole from the air outlet of the draught fan.

3. The inflatable U-shaped pillow as claimed in claim 2, wherein a storage groove is arranged on an edge of the storage chamber, and the connector is placed in the storage groove.

4. The inflatable U-shaped pillow as claimed in claim 3, wherein a notch of the storage groove gradually becomes smaller from an opening of the storage groove to a bottom of the storage groove, and a middle portion of the storage groove is adapted to a size of the connector.

5. The inflatable U-shaped pillow as claimed in claim 2, wherein the body comprises a first end, a second end and a third end between the first end and the second end; the inflatable hole is arranged on the first end of the body, the inflatable device is arrange on the first end of the body.

6. The inflatable U-shaped pillow as claimed in claim 2, wherein the body comprises a first end, a second end and a third end between the first end and the second end; the inflatable hole is arranged on the third end of the body, the inflatable device is arranged on the third end of the body.

7. The inflatable U-shaped pillow as claimed in claim 2, wherein the body comprises a first end, a second end and a third end between the first end and the second end; the number of the inflatable hole is two, two inflatable holes are arranged on the first and second end of the body, respectively, the number of the inflatable device is two, two inflatable devices are arranged on the first and second end of the body, respectively.

8. The inflatable U-shaped pillow as claimed in claim 2, wherein an air outlet is arranged on the inflatable device to vent gas.

9. The inflatable U-shaped pillow as claimed in claim 2, wherein the connector comprises a first connector.

10. The inflatable U-shaped pillow as claimed in claim 2, wherein the connector comprises a first connector and a second connector.

11. The inflatable U-shaped pillow as claimed in claim 2, wherein the connector comprises a first connector, a second connector and a third connector.

12. The inflatable U-shaped pillow as claimed in claim 2, wherein the inflatable device further comprises an air compressor connected to the draught fan.
